(19) United States
(12) Patent Application Publication
(10) Pub. No.: US 2025/0233626 A1
(43) Pub. Date: Jul. 17, 2025

(54) MULTI-LAYER TRANSMISSION OVER NEAR-FIELD MULTI-INPUT MULTI-OUTPUT (MIMO) CHANNELS

(71) Applicant: Lenovo (United States) Inc., Morrisvlle, NC (US)

(72) Inventor: Venkata Srinivas Kothapalli, Aurora, IL (US)

(21) Appl. No.: 19/097,599

(22) Filed: Apr. 1, 2025

(51) Int. Cl. H04B 7/0456

(52) U.S. Cl. CPC H04B 7/0456

(57) ABSTRACT

Various aspects of the present disclosure relate to performing multi-layer precoding for near-field multiple-input multiple-output (MIMO) channels. A transmitter may select, for each layer (e.g., or eigen-channel or eigen-mode) of multiple MIMO layers, a symbol from a signal constellation rotated at an angle that is unique to/for the layer (with respect to the other layers) and precode (or pre-multiply) a symbol vector of the symbols selected for each layer with a unitary matrix. The transmitter may then transmit an indication to a receiver that identifies the multi-layer precoding for the data transmission.

### TECHNICAL FIELD

The present disclosure relates to wireless communications, and more specifically to multi-layer transmission over near-field multiple-input multiple-output (MIMO) channels.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like)) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., 5G-advanced (5G-A), sixth generation (6G)).

MIMO involves the use of multiple transmission and receiving antennas at an NE, such as a base station. For example, a base station may include multiple antenna panels having hundreds (or more) of antennas. MIMO, or massive MIMO, may provide various benefits for the wireless communications system, including an increased network capacity, improved coverage, enhanced performance for UEs, and so on.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that support or implement multi-layer transmission over near-field MIMO channels.

A first node for wireless communication is described. The first node may be configured to, capable of, or operable to perform one or more operations as described herein. For example, the first node may comprise at least one memory and at least one processor coupled with the at least one memory and configured to cause the first node to perform a multi-layer precoding of data to be transmitted over multiple MIMO layers, wherein the multi-layer precoding includes selecting, for each layer of the multiple MIMO layers, a symbol from a signal constellation rotated at an angle that is unique to the layer and precoding a symbol vector of the selected symbols with a unitary matrix and transmit an indication to a second node that identifies the performed multi-layer precoding.

A method performed or performable by the first node is described. The method may comprise performing a multi-layer precoding of data to be transmitted over multiple MIMO layers, wherein the multi-layer precoding includes selecting, for each layer of the multiple MIMO layers, a symbol from a signal constellation rotated at an angle that is unique to the layer and precoding a symbol vector of the selected symbols with a unitary matrix and transmitting an indication to a second node that identifies the performed multi-layer precoding.

In some implementations of the first node and method described herein, the first node and method may further be configured to, capable of, performed, performable, or operable to transmit each symbol of the precoded symbol vector over a corresponding layer of the multiple MIMO layers.

In some implementations of the first node and method described herein, the MIMO layers include two or more layers, and wherein a first symbol selected for a first layer is associated with a signal constellation that is rotated at zero degrees and a second symbol selected for a second layer is associated with a signal constellation that is rotated at an angle with respect to the signal constellation that is rotated at zero degrees.

In some implementations of the first node and method described herein, each layer of the multiple MIMO layers is an eigen-channel or eigen-mode.

In some implementations of the first node and method described herein, the unitary matrix is a Walsh-Hadamard matrix.

In some implementations of the first node and method described herein, the signal constellation is a phase shift keying (PSK) constellation or a Quadrature Amplitude Modulation (QAM) constellation.

In some implementations of the first node and method described herein, the first node and method may further be configured to, capable of, performed, performable, or operable to determine whether to perform the multi-layer precoding for the data to be transmitted.

In some implementations of the first node and method described herein, the first node and method may further be configured to, capable of, performed, performable, or operable to determine whether to perform the multi-layer precoding for the data to be transmitted based on a channel state information (CSI) report received from the second node.

In some implementations of the first node and method described herein, the first node and method may further be configured to, capable of, performed, performable, or operable to determine whether to perform the multi-layer precoding for the data to be transmitted based on an indication received from the second node or another network node.

In some implementations of the first node and method described herein, the first node and method may further be configured to, capable of, performed, performable, or operable to perform the multi-layer precoding for the data to be transmitted based on a change in conditions for a communication channel between the first node and the second node.

A second node for wireless communication is described. The second node may be configured to, capable of, or operable to perform one or more operations as described herein. For example, the second node may comprise at least one memory and at least one processor coupled with the at least one memory and configured to cause the second node to receive, from a first node, multiple precoded symbols over multiple MIMO layers, wherein the multiple precoded symbols result from a multi-layer precoding of data, including selecting, for each layer of the MIMO layers, a symbol from a signal constellation rotated at an angle that is unique to the layer and precoding a symbol vector of the symbols selected for each layer with a unitary matrix, and decode the received multiple precoded symbols.

A method performed or performable by the first node is described. The method may comprise receiving, from a first node, multiple precoded symbols over multiple MIMO layers, wherein the multiple precoded symbols result from a multi-layer precoding of data, including selecting, for each layer of the MIMO layers, a symbol from a signal constellation rotated at an angle that is unique to the layer and precoding a symbol vector of the symbols selected for each layer with a unitary matrix, and decoding the received multiple precoded symbols.

In some implementations of the second node and method described herein, the second node and method may further be configured to, capable of, performed, performable, or operable to decode the received multiple precoded symbols by collectively decoding all received multiple precoded symbols.

In some implementations of the second node and method described herein, the second node and method may further be configured to, capable of, performed, performable, or operable to receive, prior to receiving the multiple precoded symbols, an indication that identifies the performed multi-layer precoding.

In some implementations of the second node and method described herein, each layer of the multiple MIMO layers is an eigen-channel or eigen-mode.

In some implementations of the second node and method described herein, the unitary matrix is a Walsh-Hadamard matrix.

In some implementations of the second node and method described herein, signal constellation is a PSK constellation or a QAM constellation.

### BRIEF DESCRIPTION OF THE DRAWINGS

FIG. 1 illustrates an example of a wireless communications system in accordance with aspects of the present disclosure.

FIG. 2 illustrates example communications between a transmitting node and a receiving node in accordance with aspects of the present disclosure.

FIG. 3 illustrates an example of performing multi-layer precoding in accordance with aspects of the present disclosure.

FIG. 4 illustrates an example of a UE in accordance with aspects of the present disclosure.

FIG. 5 illustrates an example of a processor in accordance with aspects of the present disclosure.

FIG. 6 illustrates an example of an NE in accordance with aspects of the present disclosure.

FIG. 7 illustrates a flowchart of a method performed by a UE in accordance with aspects of the present disclosure.

FIG. 8 illustrates a flowchart of a method performed by an NE in accordance with aspects of the present disclosure.

### DETAILED DESCRIPTION

The present disclosure relates to methods, apparatuses, and systems that provide, support, implement, and/or introduce enhanced multi-layer transmission over near-field MIMO channels. Using channel knowledge (e.g., from received channel state information (CSI)), a transmitter (e.g., an NE) may pre-process (e.g., precode or beamform) a signal to be transmitted to a receiver (e.g., a UE). For a MIMO channel, the transmitter may employ eigen-beamforming, where multiple data streams are transmitted along multiple eigen-modes of the MIMO channel.

For example, eigen-beamforming decomposes a MIMO channel into n number of SISO (single-input single output) eigen-channels, where n is a rank of a MIMO channel matrix H, and a gain of an i^{th} eigen-channel is equal to the i^{th} singular value of the channel H. Singular values of a channel matrix may have varying magnitudes that result in different eigen-channels having different gains. Numerical algorithms that compute singular values of a matrix through singular valued decomposition (SVD) will produce ordered singular values, which leads to a first singular value having a higher magnitude than a second singular value, the second singular value having a higher magnitude than a third singular value, and so on. Formally, let σᵢ≥0, 1≤i≤n denote the singular values of H, where σ₁≥σ₂≥ . . . ≥σₙ≥0 and n=min(r, t) is a maximum possible rank of H. Thus, symbols sent over the first eigen-channel realize a better channel gain than the symbols sent over the second eigen-channel, and so on.

Often, the lower ordered singular values may be lower than higher order singular values, causing a large number of errors for symbols/data transmitted over corresponding eigen-channels. Such issues can increase for near-field MIMO channels. For example, since a rank of the matrix H is equal to the number of its non-zero singular values, a rank n MIMO channel H may be able to send n message symbols per channel use (or, equivalently, n data streams or symbol streams). Also, an eigen-channel (or layer) and a rank n MIMO channel H may enable simultaneously transmission of n message symbols (or n symbol streams), over the n layers. This may be referred to a k-layer transmission, when k≤n symbols are sent simultaneously (e.g., per channel use) over k eigen-channels.

The channel rank and magnitude of the singular value for a MIMO channel are based on a presence of reflectors in a physical propagation medium for a channel, a number of paths between a transmitter and a reflector, and other characteristics or parameters. In a far-field regime, when there is only a direct path between each transmitting antenna and each receive antenna that resulting in a line-of-sight (LoS) component with no multi-path propagation between the transmitter and the receiver, an associated channel matrix will be rank deficient. For example, the channel matrix may have a unit rank with only one non-zero singular value, facilitating transmission of one symbol stream per channel.

In contrast, in a near-field regime, a channel matrix will not be rank deficient, despite LoS with no multi-path propagation within a channel. Instead, a LoS channel matrix will be full rank, with all singular values being non-zero values. Specifically, for near-field MIMO channels, the first few singular values may have a high value, while the remaining singular values may be significantly smaller (when compared to the first few singular values). Thus, the near-field MIMO channel is not rank deficient, an associated channel matrix will exhibit a high condition number (e.g., a ratio of a maximum singular value to a minimum singular value amongst all of the singular values). It follows that layers/eigen-channels/eigen-modes corresponding to the lower singular values are not useful for transmitting symbol streams, as they would introduce or result in high symbol (or, bit) errors, among other drawbacks.

The technology described herein introduces a precoding method that enhances or improves the reliability of data transmission over weaker layers (e.g., weaker eigen-channels or eigen-modes) of near-field MIMO channels. For example, the precoding method may perform a multi-layer precoding for near-field MIMO channels. A transmitter may select, for each layer (e.g., or eigen-channel or eigen-mode) of multiple MIMO layers, a symbol from a signal constellation rotated at an angle that is unique to/for the layer (with respect to the other layers) and precode (or pre-multiply) a symbol vector of the symbols selected for each layer with a unitary matrix. The transmitter may then transmit an indication to a receiver that identifies the multi-layer precoding for the data transmission.

In doing so, the technology described herein may improve and/or enhance the reliability of data transmissions over weaker layers of MIMO channels, such as near-field MIMO channels, by realizing a spatial multiplexing gain and data throughput for the weaker layers, among other benefits.

Aspects of the present disclosure are described in the context of a wireless communications system.

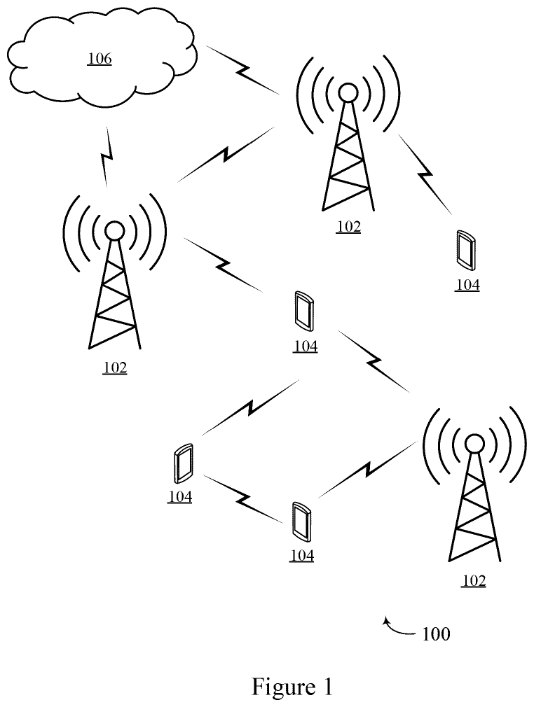

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, the technology provides for multi-layer precoding (pre-multiplying) of near-field MIMO channels for data transmissions over multiple layers of the MIMO channels.

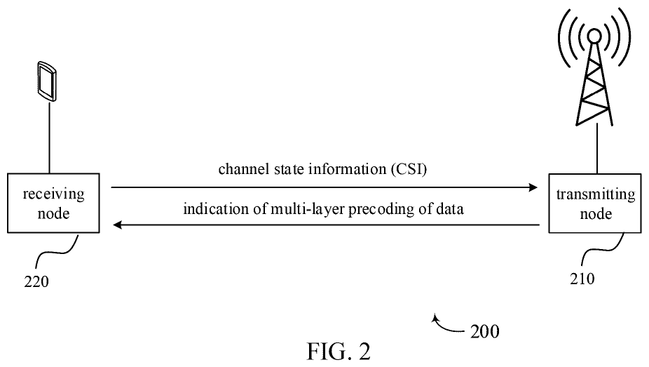

FIG. 2 illustrates example communications 200 between a transmitting node 210 and a receiving node 220 in accordance with aspects of the present disclosure. The receiving node 220, which may be associated with the UE 104, may perform various CSI measurements, and transmit the CSI (or other channel information) to the transmitting node 210. The transmitting node 210, using the CSI, may perform multi-layer precoding for data transmitted over a near-field MIMO channel, and transmit an indication of the multi-layer precoding to the receiving node 220.

For example, the transmitting node 210 may determine to perform the multi-layer precoding based on the CSI indicating that singular values for layers of the near-field MIMO channels have relatively low values. As another example, the transmitting node 210 may determine to perform the multi-layer precoding based on an indication received from the receiving node 220 or another network node and/or based on a change in conditions for a communication channel (e.g., indicated by the CSI and/or the indication). Based on the determination, the transmitting node 210 performs the multi-layer precoding (or pre-multiplying), by selecting, for each layer of the multiple MIMO layers, a symbol from a signal constellation (e.g., a BSK or QAM constellation) rotated at an angle that is unique to the layer and precoding a symbol vector of the symbols selected for each layer with a unitary matrix.

Upon receiving the indication and a data transmission (e.g., multiple precoded symbols encoded via multi-layer precoding, the receiving node 220 may decode the received multiple precoded symbols to extract the data transmission. While the receiving node 220 (e.g., a second node) is associated with the UE 104 and the transmitting node 210 (e.g., a first node) is associated with the NE 102 (e.g., a base station), in some cases the UE 104 may be a transmitting node (e.g., a first node) and the NE 102 may be a receiving node (e.g., a second node).

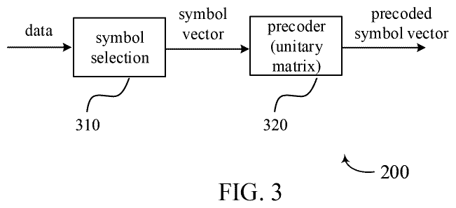

FIG. 3 illustrates an example of performing multi-layer precoding 300 in accordance with aspects of the present disclosure. First, data is received by a symbol selection block 310, which selects, for each layer of multiple MIMO layers, a symbol from a signal constellation (e.g., a BSK or QAM constellation), where the symbol is rotated at an angle (e.g., zero degrees, 15 degrees, 30 degrees, and so on) that is unique to the layer.

A signal constellation (or constellation, QAM constellation, BSK constellation, symbol constellation, and so on) is a collection or set (e.g., a signal set) of real-valued or complex-valued symbols. Note that, a signal constellation can also be considered as a set, whose elements are nothing but the symbols. As a first example, a binary phase shift keying (BPSK) constellation or a BPSK signal set includes two symbols, +1 and −1, and the BPSL constellation is denoted by [symbol] _{BPSK}={+1, −1}.

As another example, a 4-QAM constellation includes 4 symbols and the 4-QAM constellation (e.g., 4-QAM signal set) may be expressed as [symbol] _{4-QAM}={1+j, 1−j, −1+j, −1−j}, where j=\sqrt{−1}. Generally, an M-ary QAM (e.g., an M-QAM constellation or signal set comprises M symbols. For example, when M=2^{k} (where k is a positive integer), the constellation is called a square QAM constellation, because all the symbols in the constellation, when plotted over a two-dimensional plane, form the geometric shape of a square.

Rotating a constellation (or, a signal set) involves multiplying each symbol in the constellation with e^{jθ}, where 0<θ<2π. If [symbol] _{M-QAM} denotes a regular M-QAM constellation, then a rotated M-QAM constellation, with rotation angle θ, is denoted by e^{jθ} [symbol] _{M-QAM}. Thus, if [symbol] denotes a conventional symbol/signaling constellation, then e^{jθ} [symbol] denotes a rotated constellation [symbol] rotated by an angle θ. As an example, a regular BPSK constellation (denoted as [symbol] _{BPSK}={+1, −1} and rotated by

$$θ = \frac{π}{4}$$

includes the symbols

$${e}^{j \frac{π}{4}} and \text{-} {e}^{j \frac{π}{4}}$$

and the BPK constellation rotated by

$$θ = \frac{π}{4}$$

is denoted by

$${𝒮}_{BPSK}^{\frac{π}{4}} = \{ + {e}^{j \frac{π}{4}} , - {e}^{j \frac{π}{4}} \} .$$

Thus, a BPSK constellation rotated by an angle θ=π is equal to the original BPSK constellation itself (e.g., [symbol] _{BPSK}^{π}= [symbol] _{BPSK}).

As another example, a 4-QAM constellation (e.g., [symbol] _{4-QAM}={1+j, 1−j, −1+j, −1−j}, where j=\sqrt{−1}) is rotated by an angle θ, with

$$0 < θ < \frac{π}{2} ,$$

resulting in a rotated 4-QAM constellation of [symbol] _{4-QAM}^{θ}=e^{jθ} [symbol] _{4--QAM}={e^{jθ}(1+j), e^{jθ}(1−j), e^{jθ}(−1+j), e^{jθ}(−1−j)}. Thus, when θ is equal to a multiple of

$$\frac{π}{4} ,$$

the rotated 4-VAM constellation would be same as the unrotated 4-QAM constellation.

Next, a precoder block 320, via a unitary matrix, pre-multiplies a symbol vector of the symbols selected for each layer with a unitary matrix, such as a Walsh-Hadamard (WH) matrix. For example, a WH matrix, having a dimension N×N, where N=2^{k}, with k a positive integer, may be denoted by W_{N}. In W_{N}, columns and rows are of unit norm with entries equal to ±1/\sqrt{N} and W_{N}^{T}W_{N}=I_{N}=W_{N}W_{N}^{T}, where I_{N} denotes an identity matrix of size N×N.

A 2×2 WH matrix, denoted by W₂_{¹}, is given by:

$${W}_{{2}^{1}} = {W}_{2} = \frac{1}{\sqrt{2}} [ \begin{matrix}1 & 1 \\ 1 & - 1\end{matrix} ]$$

A 2^{k}×2^{k} WH matrix, where i is a positive integer, can be constructed based on a recursive relation:

$${W}_{{2}^{k}} = [ \begin{matrix}{W}_{{2}^{k - 1}} & {W}_{{2}^{k - 1}} \\ {W}_{{2}^{k - 1}} & - {W}_{{2}^{k - 1}}\end{matrix} ]$$

For example, a 4×4 WH matrix, denoted by W₂_{²}, can be constructed from W₂_{¹} as:

$${W}_{{2}^{2}} = {W}_{4} = [ \begin{matrix}{W}_{{2}^{1}} & {W}_{{2}^{1}} \\ {W}_{{2}^{1}} & - {W}_{{2}^{1}}\end{matrix} ] = \frac{1}{\sqrt{4}} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$$

In some cases, the unitary matrix may be other matrices, such as a matrix U of dimension N×N, where U^{T}U=I_{N}=UU^{T}, and where I_{N} is an identity matrix of size N×N.

As described herein, the transmitting node 210 (or transmitter) may perform precoding using rotated constellations and WH matrices.

### Example of Data Transmission Over Two Layers

The following example, based on a two-layer transmission over a point-to-point MIMO channel H having dimensions of r×t with t Tx antennas at a transmitting (Tx) node and r antennas at a receiving (Rx) node (e.g., a point-to-point communication, illustrates the performed precoding.

For example, a symbol constellation [symbol] ^{L}^{¹} is used for transmission on layer 1, and symbol constellation [symbol] ^{L}^{²} is used for transmission on layer 2. As described herein, a signal constellation is a set of symbols. When [symbol] ^{L}^{¹}∩ [symbol] ^{L}^{²}=Ø, where Ø indicates an empty set, the constellations [symbol] ^{L}^{¹} and [symbol] ^{L}^{²} does not contain any common symbols (e.g., every symbol in [symbol] ^{L}^{¹} is different from every symbol in [symbol] ^{L}^{²}). The case [symbol] ^{L}^{¹}∩ [symbol] ^{L}^{²}≠Ø corresponds to a situation when one or more symbols in [symbol] ^{L}^{¹} are same as one or more symbols in [symbol] ^{L}^{²}.

Let s₁ and s₂ be the symbols to be sent over layer 1 and layer 2, respectively and let s=[s₁ s₂]^{T} denotes a symbol vector to be transmitted to the receiver.

In a first scenario, [symbol] ^{L}^{¹}= [symbol] ^{L}^{²} or [symbol] ^{L}^{¹}∩ [symbol] ^{L}^{²}≠Ø (e.g., when one or more symbols in [symbol] ^{L}^{¹} are same as one or more symbols in [symbol] ^{L}^{²}). The transmitter may perform the following steps or operations. First, the transmitter keeps [symbol] ^{L}^{¹}, the constellation to be used on layer 1, intact. Thus, symbols to be sent over layer 1 are chosen from the symbol constellation [symbol] ^{L}^{¹}.

The transmitter then rotates [symbol] ^{L}^{²}, the constellation to be used over layer 2, by an angle θ, to obtain constellation e^{jθ} [symbol] ^{L}^{²}. Thus, the symbols to be sent over layer 2 are selected from the constellation e^{jθ} [symbol] ^{L}^{²}. The rotation angle θ may be chosen such that every symbol in the rotated constellation e^{jθ} [symbol] ^{L}^{²} is different from every symbol in [symbol] ^{L}^{¹}. If the constellations [symbol] ^{L}^{¹} and e^{jθ} [symbol] ^{L}^{²} are sets, the intersection between the set of symbols [symbol] ^{L}^{¹} and the set of symbols e^{jθ} [symbol] ^{L}^{²} is a null set. The constellations [symbol] ^{L}^{¹} and e^{jθ} [symbol] ^{L}^{²}, therefore, do not have any common symbols, (e.g., [symbol] ^{L}^{¹}∩e^{jθ} [symbol] ^{L}^{²}=Ø).

Next, s₁ and s₂ are symbols to be sent over layer 1 and layer 2, respectively. As discussed herein, symbol s₁ is from the constellation [symbol] ^{L}^{¹} and symbol s₂ is from the constellation e^{jθ} [symbol] ^{L}^{²}. Let s=[s₁ s₂]^{T}, which denotes the symbol vector to be transmitted, including the symbols to be sent on layer 1 and layer 2, where s₁∈ [symbol] ^{L}^{¹} and s₂∈e^{jθ} [symbol] ^{L}^{²}. The transmitter precodes (or pre-multiplies) the vector s=[s₁ s₂]^{T} with a 2×2 WH matrix W₂ to obtain precoded symbol vector x=[x₁ x₂]^{T}, where x=W₂ s. Then, the transmitter sends or transmits the symbol x₁ over layer 1 and the symbol x₂ over layer 2.

In some cases, instead of keeping the constellation [symbol] ^{L}^{¹} intact and rotating the constellation [symbol] ^{L}^{²}, the transmitter may rotate the constellation [symbol] ^{L}^{¹} by an angle θ to obtain e^{jθ} [symbol] ^{L}^{¹} and keep the constellation [symbol] ^{L}^{²} intact. The rotation of [symbol] ^{L}^{¹}may be performed such that the constellations e^{jθ} [symbol] ^{L}^{¹} and [symbol] ^{L}^{²} does not include any common symbols (e.g., the rotation angle realizes e^{jθ} [symbol] ^{L}^{¹}∩ [symbol] ^{L}^{²}=Ø).

When the symbols x₁ and x₂ are transmitted over layer 1 and layer 2, respectively, the received symbols are given by: z₁=σ₁x₁+n₁ (over layer 1) and z₂=σ₂x₂+n₂ (over layer 2), where σ₁ and σ₂ are the first and the second singular values, respectively, of a MIMO channel.

Upon receiving the precoded symbols sent by the transmitter, the receiver jointly decodes the symbols received on both the layers with respect to the constellations used by the transmitter. The estimates of the transmitted symbols s₁ and s₂, denoted by ŝ₁ and ŝ₂, respectively, are obtained by:

$${\hat{s}}_{1} , {\hat{s}}_{2} = {arg min}_{{s}_{1}^{′} ∈ {𝒮}^{L} 1 , {s}_{2}^{′} ∈ {e}^{j θ} {𝒮}^{L} 2} {‖ z - Σ {W}_{2} {s}^{′} ‖}_{2}$$

where the vector z=[z₁z₂]^{T}, the vector s′=[s′₁ s′₂]^{T}, the matrix Σ is a 2×2 diagonal matrix with its first diagonal entry equal to σ₁ and its second diagonal entry equal to σ₂ and W₂ is the 2×2 Walsh-Hadamard matrix.

The receiver jointly or collectively decodes the transmitted symbols (e.g., due to the coupling of the symbols via the WH matrix), which may increase the complexity of the receiver. Further, one of the transmitted symbols (in this case, symbol s₂) is from a rotated constellation, and when the constellation corresponding to a first eigenchannel is rotated, then the receiver may decode the first symbol with respect to the rotated constellation e^{jθ} [symbol] ^{L}^{¹} and decode the second symbol should be with respect to an un-rotated (e.g., a rotation of zero degrees) constellation [symbol] ^{L}^{²}.

In some cases, such as via eigen beamforming without multi-layer precoding, the receiver may decode received symbols separately. For example, the receiver may obtain ŝ₁ and ŝ₂, the estimates of the transmitted symbols s₁ and s₂, respectively, through two different operations, such as:

$${\hat{s}}_{1} = {arg min}_{{s}_{1}^{′} ∈ {𝒮}^{L} 1} ‖ {z}_{1} - {σ}_{1} {s}_{1}^{′} ‖ and$$

$${\hat{s}}_{2} = {arg min}_{{s}_{2}^{′} ∈ {e}^{j θ} {𝒮}^{L} 2} ‖ {z}_{2} - {σ}_{2} {s}_{2}^{′} ‖$$

In a second scenario, [symbol] ^{L}^{¹}∩ [symbol] ^{L}^{²}=Ø, where [symbol] ^{L}^{¹}and [symbol] ^{L}^{²} have no common symbols, and the transmitter may not rotate the signal constellations during the multi-layer precoding. For example, given s₁ and s₂ as the symbols to be sent over layer 1 and layer 2, respectively, where symbol s₁ is from the constellation [symbol] ^{L}^{¹} and symbol s₂ is from the constellation [symbol] ^{L}^{²}, and [symbol] ^{L}^{¹}∩ [symbol] ^{L}^{²}=Ø. Further, s=[s₁ s₂]^{T} denotes the symbol vector to be transmitted, comprising of both the symbols to be sent on layer 1 and layer 2. The transmitter may precode (or pre-multiply) the vector s=[s₁ s₂]^{T} with a 2×2 WH matrix W₂ to obtain precoded symbol vector x=[x₁ x₂]^{T}, where x=W₂ s, and transmit symbol x₁ over layer 1 and symbol x₂ over layer 2.

### Example of Data Transmission Over Four Layers

The next example is based on a four-layer transmission over a point-to-point MIMO channel H, where a symbol constellation to be used for transmission on layer k is denoted by [symbol] ^{L}^{^{k}}, k=1, . . . , 4. Further, when [symbol] ^{L}^{¹}∩ [symbol] ^{L}^{²}∩ [symbol] ^{L}^{³}∩ [symbol] ^{L}^{⁴}=Ø, where Ø indicates an empty set, the constellations [symbol] ^{L}^{¹}, [symbol] ^{L}^{²}, [symbol] ^{L}^{³}, and [symbol] ^{L}^{⁴} do not contain any common symbols (e.g., every symbol in [symbol] is different from every symbol in [symbol] , for k₁≠k₂, 1≤k₁, k₂≤4). Thus, [symbol] ^{L}^{¹}∩ [symbol] ^{L}^{²}∩ [symbol] ^{L}^{³}∩ [symbol] ^{L}^{⁴}≠Ø corresponds to a situation where one or more constellations among [symbol] ^{L}^{¹}, [symbol] ^{L}^{²}, [symbol] ^{L}^{³}, and [symbol] ^{L}^{⁴} have one or more common symbols. Also, sₖ∈ [symbol] ^{L}^{^{k}} denotes the symbol to be transmitted on layer k, where k=1, . . . , 4 and s=[s₁ s₂ s₃ s₄]^{T} denotes the symbol vector to be transmitted.

In a first scenario, [symbol] ^{L}^{¹}∩ [symbol] ^{L}^{²}∩ [symbol] ^{L}^{³}∩ [symbol] ^{L}^{⁴}≠Ø, where one or more constellations [symbol] ^{L}^{¹}, [symbol] ^{L}^{²}, [symbol] ^{L}^{³} and [symbol] ^{L}^{⁴} have one or more common symbols. The transmitter may perform the following steps or operations. First, the transmitter keeps one of the constellations intact and rotates the other constellations such that there are no common symbols across all the four constellations. For example, the transmitter may keep [symbol] ^{L}^{¹}, the constellation corresponding to layer 1, intact and rotate the constellations, [symbol] ^{L}^{²}, [symbol] ^{L}^{³}, [symbol] ^{L}^{⁴} corresponding to layer 2, layer 3, and layer 4, respectively, to obtain e^{jθ}^{²} [symbol] ^{L}^{²}, e^{jθ}^{³} [symbol] ^{L}^{³} and e^{jθ}^{⁴} [symbol] ^{L}^{^{4.}} The values θ₂, θ₃ and θ₄ may be chosen such that the three rotated constellations e^{jθ}^{²} [symbol] ^{L}^{²}, e^{jθ}^{³} [symbol] ^{L}^{³}, e^{θ}^{⁴} [symbol] ^{L}^{⁴} and the constellation [symbol] ^{L}^{¹} does not have any common symbols, resulting in [symbol] ^{L}^{¹}∩ [symbol] ^{L}^{²}∩ [symbol] ^{L}^{³}∩ [symbol] ^{L}^{⁴}=Ø.

Thus, after rotation of the constellations corresponding to layers 2, 3, and 4, the symbols to be sent on layer 1 are selected from [symbol] ^{L}^{¹}, the symbols to be sent on layer 2 are selected from e^{jθ}^{²} [symbol] ^{L}^{²}, the symbols to be sent on layer 3 are selected from e^{jθ}^{³} [symbol] ^{L}^{³}, and the symbols to be sent on layer 4 are selected from e^{jθ}^{⁴} [symbol] ^{L}^{⁴}. Next, s=[s₁ s₂ s₃ s₄]^{T} is the symbol vector to be transmitted, where the symbols are chosen from the constellations (rotated or un-rotated), such as: s₁∈ [symbol] ^{L}^{¹} and s₂∈e^{jθ}^{²} [symbol] ^{L}^{²}, s₃∈e^{jθ}^{³} [symbol] ^{L}^{³}, s₄∈e^{jθ}^{⁴} [symbol] ^{L}^{⁴}.

The transmitter precodes (or pre-multiplies) the vector s=[s₁ s₂ s₃ s₄]^{T}with a 4×4 WH matrix W₄ to obtain a precoded symbol vector x=[x₁ x₂ x₃ x₄]^{T}, where x=W₄ s. Then, the transmitter transmits symbol x₁ over layer 1, symbol x₂ over layer 2, symbol x₃ over layer 3, and symbol x₄ over layer 4.

As described herein, the receiver, upon receiving the precoded symbols sent by the transmitter, jointly or collectively decodes the symbols received on all of the layers with respect to the constellations used by the transmitter.

In a second scenario, [symbol] ^{L}^{¹}∩ [symbol] ^{L}^{²}∩ [symbol] ^{L}^{³}∩ [symbol] ^{L}^{⁴}=Ø, where [symbol] ^{L}^{¹}, [symbol] ^{L}^{²}, [symbol] ^{L}^{³} and [symbol] ^{L}^{⁴} have no common symbols. As described herein, the transmitter does not rotate the constellations, and precodes the symbols to be sent on the four layers with WH matrix of appropriate size, which is 4×4 in this scenario. For example, if sₖ∈ [symbol] ^{L}^{^{k}} denotes the symbol to be transmitted on layer k, where k=1, . . . , 4 and s=[s₁ s₂ s₃ s₄]^{T} denotes the symbol vector to be transmitted, the transmitter precodes (or pre-multiplies) the vector s=[s₁ s₂ s₃ s₄]^{T} with a 4×4 WH matrix W₄ to obtain a precoded symbol vector x=[x₁ x₂ x₃ x₄]^{T}, where x=W₄ s. The transmitter may then transmit symbol x₁ over layer 1, symbol x₂ over layer 2, symbol x₃ over layer 3, and symbol x₄ over layer 4.

### Example of Data Transmission Over N=2^{k} Layers

The next example is based on a transmission over a point-to-point MIMO channel H having N=2 Layers (where k is positive). For example, N may be 2, 4, 8, 16, and so on. In a first scenario, [symbol] ^{L}^{¹}∩ [symbol] ^{L}^{²} . . . ∩ [symbol] ^{L}^{^{N−1}}∩ [symbol] ^{L}^{^{N}}≠Ø, where when one or more constellations among [symbol] ^{L}^{¹}, [symbol] ^{L}^{²} . . . , [symbol] ^{L}^{²}^{k} have one or more common symbols. The transmitter may perform the following steps or operations. First, the transmitter rotates N₁ constellations among the N constellations, where 1≤N₁≤N, such that there are no common symbols across all the resulting constellations after rotating the N₁ number of constellations.

In some cases, the transmitter may keep one of the constellations intact and rotate the other N−1 constellations such that there are no common symbols across all the N constellations. In some cases, the transmitter may rotate all the constellations such that there are no common symbols across the rotated constellations. Thus, the transmitter may rotate N₁ constellations among the N constellations, where 1≤N₁≤N.

As described herein, s=[s₁ s₂ . . . s_{N}]^{T} is the symbol vector to be transmitted, where the symbols are chosen from the constellations (rotated or un-rotated), as described herein. The transmitter precodes (or pre-multiplies) the vector s=[s₁ s₂ . . . s_{N}]^{T} with an N×N WH matrix W_{N} to obtain a precoded symbol vector x=[x₁ x₂ . . . s_{N}]^{T}, where x=W_{N} S. The transmitter may then transmit symbol xₖ over layer k, where k=1, . . . , N.

In a second scenario, [symbol] ^{L}^{¹}∩ [symbol] ^{L}^{²} . . . ∩ [symbol] ^{L}^{^{N−1}}∩ [symbol] ^{L}^{^{N}}=Ø, where [symbol] ^{L}^{¹}, [symbol] ^{L}^{²} . . . , [symbol] ^{L}^{⁴} have no common symbols. As described herein, the transmitter does not rotate any constellations and precode the symbols to be sent on the N layers with a WH matrix of appropriate size, which, in this scenario, is N×N, where N=2^{k} (k a positive integer). Then, when s=[s₁ s₂ . . . s_{N}]^{T} is the symbol vector to be transmitted, where the symbols are chosen from the constellations decided for each layer, the transmitter precodes (or pre-multiplies) the vector s=[s₁ s₂ . . . s_{N}]^{T} with an N×N WH matrix W_{N} to obtain a precoded symbol vector x=[x₁ x₂ . . . x_{N}]^{T}, where x=W_{N} s. The transmitter may then transmit symbol xₖ over layer k, where k=1, . . . , N.

As described herein, the technology provides a multi-layer precoding method to enhance the reliability of data sent over multiple layers of MIMO channels. In other words, the multi-layer precoding may reduce the error rates (e.g., a bit error rate (BER) or block error rate (BLER) over the layers having inferior channel gain and/or layers having a poor channel quality indicator (CQI). Thus, the multi-layer precoding may enhance BER/BLER over weaker layers/eigen-channels/eigen-modes, such as for layers of near-field MIMO channels, among other benefits.

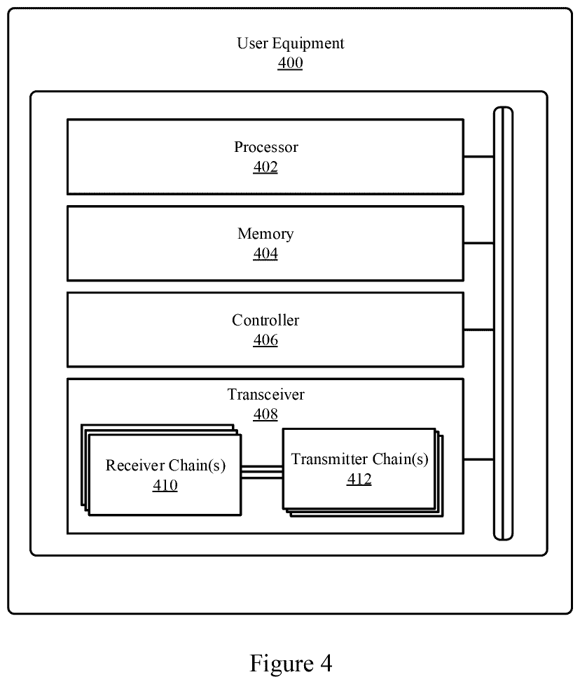

FIG. 4 illustrates an example of a UE 400 in accordance with aspects of the present disclosure. The UE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the UE 400 to perform various functions of the present disclosure.

The memory 404 may include volatile or non-volatile memory. The memory 404 may store computer-readable, computer-executable code including instructions when executed by the processor 402 cause the UE 400 to perform various functions described herein. The code may be stored in a non-transitory computer-readable medium such the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the UE 400 to perform one or more of the functions described herein (e.g., executing, by the processor 402, instructions stored in the memory 404). For example, the processor 402 may support wireless communication at the UE 400 in accordance with examples as disclosed herein. The UE 400 may be configured to support a means for receiving, from a first node, multiple precoded symbols over multiple MIMO layers, wherein the multiple precoded symbols result from a multi-layer precoding of data, including selecting, for each layer of the MIMO layers, a symbol from a signal constellation rotated at an angle that is unique to the layer and precoding a symbol vector of the symbols selected for each layer with a unitary matrix, and decoding the received multiple precoded symbols.

The controller 406 may manage input and output signals for the UE 400. The controller 406 may also manage peripherals not integrated into the UE 400. In some implementations, the controller 406 may utilize an operating system such as iOS®, ANDROID®, WINDOWS®, or other operating systems. In some implementations, the controller 406 may be implemented as part of the processor 402.

In some implementations, the UE 400 may include at least one transceiver 408. In some other implementations, the UE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas for receive the signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the processing the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

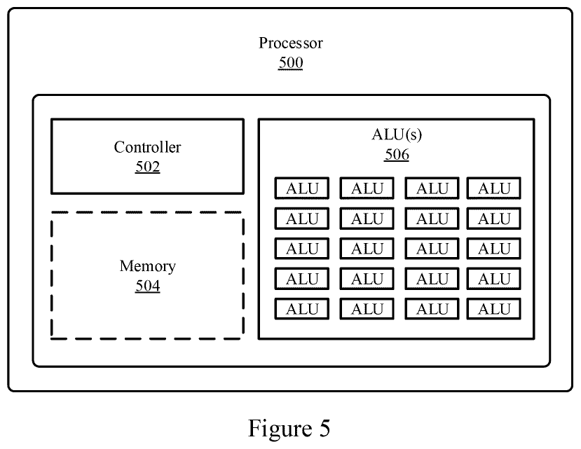

FIG. 5 illustrates an example of a processor 500 in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, which may be, for example, an L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory address of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, arithmetic logic units (ALUs), and other functional units of the processor 500.

The memory 504 may include one or more caches (e.g., memory local to or included in the processor 500 or other memory, such RAM, ROM, DRAM, SDRAM, SRAM, MRAM, flash memory, etc. In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, the controller 502, and the memory 504 may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein. The processor 500 may be configured to or operable to support a means for receiving, from a first node, multiple precoded symbols over multiple MIMO layers, wherein the multiple precoded symbols result from a multi-layer precoding of data, including selecting, for each layer of the MIMO layers, a symbol from a signal constellation rotated at an angle that is unique to the layer and precoding a symbol vector of the symbols selected for each layer with a unitary matrix, and decoding the received multiple precoded symbols.

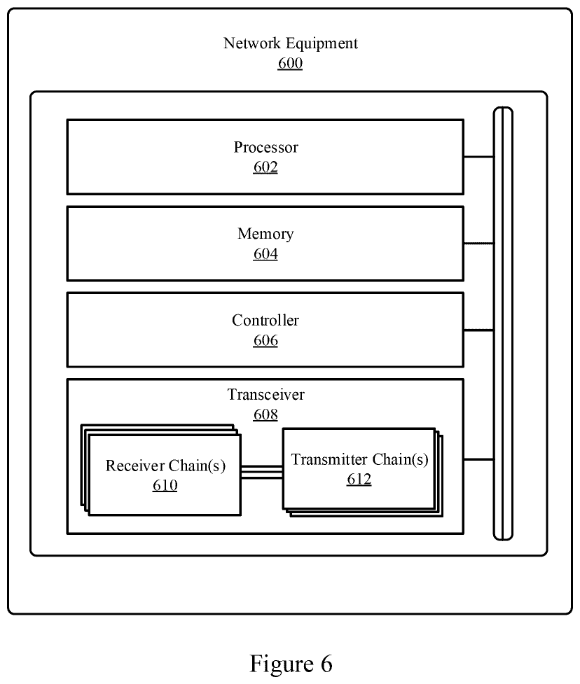

FIG. 6 illustrates an example of a NE 600 in accordance with aspects of the present disclosure. The NE 600 may include a processor 602, a memory 804, a controller 806, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the NE 600 to perform various functions of the present disclosure.

The memory 604 may include volatile or non-volatile memory. The memory 604 may store computer-readable, computer-executable code including instructions when executed by the processor 602 cause the NE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the NE 600 to perform one or more of the functions described herein (e.g., executing, by the processor 602, instructions stored in the memory 604). For example, the processor 602 may support wireless communication at the NE 600 in accordance with examples as disclosed herein. The NE 600 may be configured to support a means for performing a multi-layer precoding of data to be transmitted over multiple MIMO layers, wherein the multi-layer precoding includes selecting, for each layer of the multiple MIMO layers, a symbol from a signal constellation rotated at an angle that is unique to the layer and precoding a symbol vector of the selected symbols with a unitary matrix and transmitting an indication to a second node that identifies the performed multi-layer precoding.

The controller 606 may manage input and output signals for the NE 600. The controller 606 may also manage peripherals not integrated into the NE 600. In some implementations, the controller 606 may utilize an operating system such as iOS®, ANDROID®, WINDOWS®, or other operating systems. In some implementations, the controller 606 may be implemented as part of the processor 602.

In some implementations, the NE 600 may include at least one transceiver 608. In some other implementations, the NE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

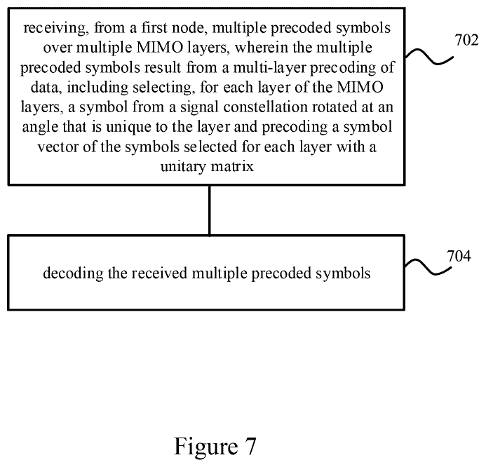

FIG. 7 illustrates a flowchart of a method in accordance with aspects of the present disclosure. The operations of the method may be implemented by a UE (e.g., as a receiving node) as described herein. In some implementations, the UE may execute a set of instructions to control the function elements of the UE to perform the described functions.

At 702, the method may include receiving, from a first node, multiple precoded symbols over multiple MIMO layers, wherein the multiple precoded symbols result from a multi-layer precoding of data, including selecting, for each layer of the MIMO layers, a symbol from a signal constellation rotated at an angle that is unique to the layer and precoding a symbol vector of the symbols selected for each layer with a unitary matrix. The operations of 702 may be performed in accordance with examples as described herein. In some implementations, aspects of the operations of 702 may be performed by a UE as described with reference to FIG. 4.

At 704, the method may include decoding the received multiple precoded symbols. The operations of 704 may be performed in accordance with examples as described herein. In some implementations, aspects of the operations of 704 may be performed a UE as described with reference to FIG. 4.

It should be noted that the method described herein describes a possible implementation, and that the operations and the steps may be rearranged or otherwise modified and that other implementations are possible.

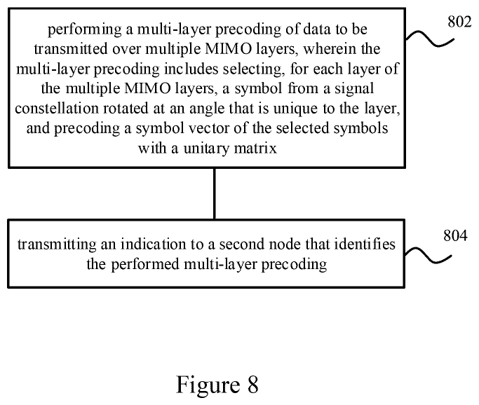

FIG. 8 illustrates a flowchart of a method in accordance with aspects of the present disclosure. The operations of the method may be implemented by an NE (e.g., as a transmitting node) as described herein. In some implementations, the NE may execute a set of instructions to control the function elements of the NE to perform the described functions.

At 802, the method may include performing a multi-layer precoding of data to be transmitted over multiple MIMO layers, wherein the multi-layer precoding includes selecting, for each layer of the multiple MIMO layers, a symbol from a signal constellation rotated at an angle that is unique to the layer and precoding a symbol vector of the selected symbols with a unitary matrix. The operations of 802 may be performed in accordance with examples as described herein. In some implementations, aspects of the operations of 802 may be performed by an NE as described with reference to FIG. 6.

At 804, the method may include transmitting an indication to a second node that identifies the performed multi-layer precoding. The operations of 804 may be performed in accordance with examples as described herein. In some implementations, aspects of the operations of 804 may be performed by an NE as described with reference to FIG. 6.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first node for wireless communication, comprising:
at least one memory; and
at least one processor coupled with the at least one memory and configured to cause the first node to:
perform a multi-layer precoding of data to be transmitted over multiple multiple-input-multiple-output (MIMO) layers, wherein the multi-layer precoding includes:
selecting, for each layer of the multiple MIMO layers, a symbol from a signal constellation rotated at an angle that is unique to the layer; and
precoding a symbol vector of the selected symbols with a unitary matrix; and
transmit, to a second node, an indication that identifies the multi-layer precoding.

2. The first node of claim 1, wherein the at least one processor is further configured to cause the first node to:
transmit each symbol of the precoded symbol vector over a corresponding layer of the multiple MIMO layers.

3. The first node of claim 1, wherein the MIMO layers include two or more layers, and wherein:
a first symbol selected for a first layer is associated with a signal constellation that is rotated at zero degrees; and
a second symbol selected for a second layer is associated with a signal constellation that is rotated at an angle with respect to the signal constellation that is rotated at zero degrees.

4. The first node of claim 1, wherein each layer of the multiple MIMO layers is an eigen-channel or eigen-mode.

5. The first node of claim 1, wherein the unitary matrix is a Walsh-Hadamard matrix.

6. The first node of claim 1, wherein the signal constellation is a phase shift keying (PSK) constellation or a Quadrature Amplitude Modulation (QAM) constellation.

7. The first node of claim 1, wherein the at least one processor is further configured to cause the first node to:
determine whether to perform multi-layer precoding for data to be transmitted over the multiple MIMO layers.

8. The first node of claim 7, wherein the at least one processor is configured to cause the first node to determine whether to perform the multi-layer precoding for the data to be transmitted based on a channel state information (CSI) report received from the second node.

9. The first node of claim 7, wherein the at least one processor is configured to cause the first node to determine whether to perform the multi-layer precoding for the data to be transmitted based on an indication received from the second node or another network node.

10. The first node of claim 7, wherein the at least one processor is configured to cause the first node to determine whether to perform the multi-layer precoding for the data to be transmitted based on a change in conditions for a communication channel between the first node and the second node.

11. A second node for wireless communication, comprising:
at least one memory; and
at least one processor coupled with the at least one memory and configured to cause the second node to:
receive, from a first node, multiple precoded symbols over multiple multiple-input multiple-output (MIMO) layers,
wherein the multiple precoded symbols result from a multi-layer precoding of data, including:
selecting, for each layer of the MIMO layers, a symbol from a signal constellation rotated at an angle that is unique to the layer; and
precoding a symbol vector of the symbols selected for each layer with a unitary matrix; and
decode the received multiple precoded symbols.

12. The second node of claim 11, wherein the at least one processor is configured to cause the second node to decode the received multiple precoded symbols by collectively decoding all received multiple precoded symbols.

13. The second node of claim 11, wherein the at least one processor is further configured to cause the second node to:
receive, prior to receiving the multiple precoded symbols, an indication that identifies the performed multi-layer precoding.

14. The second node of claim 11, wherein each layer of the multiple MIMO layers is an eigen-channel or eigen-mode.

15. The second node of claim 11, wherein the unitary matrix is a Walsh-Hadamard matrix.

16. The second node of claim 11, wherein the signal constellation is a phase shift keying (PSK) constellation or a Quadrature Amplitude Modulation (QAM) constellation.

17. A method performed by a first node, the method comprising:
performing a multi-layer precoding of data to be transmitted over multiple multiple-input-multiple-output (MIMO) layers, wherein the multi-layer precoding includes:
selecting, for each layer of the multiple MIMO layers, a symbol from a signal constellation rotated at an angle that is unique to the layer; and
precoding a symbol vector of the selected symbols with a unitary matrix; and
transmitting an indication to a second node that identifies the performed multi-layer precoding.

18. The method of claim 17, further comprising:
transmitting each symbol of the precoded symbol vector over a corresponding layer of the multiple MIMO layers.

19. The method of claim 17, wherein the MIMO layers include two or more layers, and wherein:
a first symbol selected for a first layer is associated with a signal constellation that is not rotated; and
a second symbol selected for a second layer is associated with a signal constellation that is rotated at an angle with respect to the signal constellation that is not rotated.

20. A method performed by a second node, the method comprising:
receiving, from a first node, multiple precoded symbols over multiple multiple-input multiple-output (MIMO) layers,
wherein the multiple precoded symbols result from a multi-layer precoding of data, including:
selecting, for each layer of the MIMO layers, a symbol from a signal constellation rotated at an angle that is unique to the layer; and
precoding a symbol vector of the symbols selected for each layer with a unitary matrix; and
decoding the received multiple precoded symbols.
